(19) United States
(12) Patent Application Publication
(10) Pub. No.: US 2014/0157845 A1
(43) Pub. Date: Jun. 12, 2014

(54) PARTICULATE NITRIFICATION INHIBITOR SYSTEMS

(71) Applicant: Balance Agri-Nutrients Limited, Mount Maunganui (NZ)

(72) Inventor: Terrence Smith, Tauranga (NZ)

(73) Assignee: Balance Agri-Nutrients Limited, Mount Maunganui (NZ)

(21) Appl. No.: 14/018,735

(22) Filed: Sep. 5, 2013

Related U.S. Application Data
(63) Continuation of application No. 12/736,305, filed on Dec. 9, 2010, now abandoned.

(30) Foreign Application Priority Data
Mar. 28, 2008 (NZ) 567026
Mar. 31, 2008 (NZ) 567079

(51) Int. Cl. C05G 3/08

(52) U.S. Cl. CPC C05G 3/08
USPC 71/49

(57) ABSTRACT

Particulate compositions of reverted superphosphate substantially free of free acid containing at least one nitrification inhibitor and their methods of preparation and use

The present invention relates to a phosphatic nitrification inhibitor compositions and related granules, uses, methods and processes.

Nitrification inhibitors are substances that slow or stop the conversion of soil ammonium to nitrate. In our New Zealand patent 531078 we disclose a zeolite based delivery system for nitrification inhibitors of which examples are
N-2,5-dichlorophenyl succinamic acid
2-chloro-6-trichloromethyl pyridine (“Nitrapyrin”)
dicyandiamide (“DCD or “DCDIN””) which is HN═C(NH₂)—NH—CN
zinc ethylene-bis-dithiocarbamate
2,4,6-triehloroaniline
pentachlorophenol
thio-urea
ATS (ammonium thiosulphate), and
water soluble DMPP (3,4-dimethypyrazole phosphate).

Nitrification inhibitors are of value in farm systems as they can help reduce unwanted environmental impacts of nitrogen. These impacts include the effects of nitrate leaching (which can contribute to the deterioration of waterways) and nitrous oxide emissions (which raise the level of greenhouse gases in the atmosphere). Using a nitrification inhibitor may also result in increased pasture production.

In order for the most benefit to be gained from the use of nitrification inhibitors, they should be applied before soil ammonium (derived from the urea in stock urine or fertiliser) is converted to nitrate, and also before the first drainage event of the season is due.

Results from trial work indicate that on well-drained soils, the nitrification inhibitor should be applied in April/May and July/August. The April/May application covers the high-risk. leaching period over winter; a July/August application further retains the autumn nitrogen in the system and also ensures coverage through spring.

On wetter soils with artificial drainage systems and where stock are wintered off, most nitrate leaching will occur during early winter drainage, so best results are achieved from two applications of the nitrification inhibitor around March and May.

The present invention has as an object the provision of particulate delivery systems for nitrification inhibitors based upon a phosphatic material, eg, a super phosphate (whether single super phosphate) (“SSP”), double super phosphate (“DSP”) or triple super phosphate (“TSP”), or mixtures and derivatives thereof.

It is a further or alternative object of the present invention to provide a nitrification inhibitor including granular material which includes one or more super phosphate in conjunction with one or more other material(s) so as to be a compatible with a carried nitrification inhibitor or mixture of nitrification inhibitors.

It is still a further or alternative object of the present invention to provide granular nitrification inhibitor including materials that include or have included a super phosphate yet has the pH of the matrix in contact with the nitrification inhibitor at an acceptable level.

It is a further or alternative object of the invention to use of a reverted super phosphate as a carrier or part carrier of a nitrification inhibitor, eg, DCD.

In an aspect the present invention consists in a particulate composition for pasture application in the form of particulate reverted super phosphate(s) carrying at least one nitrification inhibitor.

Preferably the reverted superphosphate is a SSP and, preferably but not necessarily the nitrification inhibitor(s) has (have) low water solubility ie, is preferably particulate (eg, DCD).

Preferably the nitrification inhibitor is from 1 to 35% w/w of the composition.

In another aspect the present invention consists in a particulate composition for soil or pasture application of reverted super phosphate carrying at least one nitrification inhibitor or particulate superphosphate(s) substantially free of any free acid and carrying at least one nitrification inhibitor.

In a further aspect the present invention consists in a particulate composition of any of the preceding kinds in admixture with a fertiliser.

In still a further aspect the present invention consists in a method of potentiating and/or stabilising the nitrification inhibition of a nitrification inhibitor (preferably but but not limited to one or both DCD and ATS) as deliverable granules which comprises or includes coupling the nitrification inhibitor prior to granulation with a reverted super phosphate or a system to provide a reverted superphosphate or a system of one or more superphosphate at least substantially free of free acid.

Optionally the superphosphate was SSP or is SSP.

In yet a further aspect the present invention consists in a synergistic or stable nitrification inhibiting particulate composition comprising or including an effective amount of a particulate reverted super phosphate (eg, SSP) carrying an effective amount of at least one nitrification inhibitor (eg, DCD).

Preferably the nitrification inhibitor is particulate DCD.

In still a further aspect the present invention consists in, in a fertiliser delivery system, particulate reverted super phosphate(s) carrying at least one nitrification inhibitor.

In still another aspect the invention is the use of any composition, fertiliser or product of the present invention on soil and/or pasture.

In another aspect the invention is granules provided by a SSP and basic material(s) carrying DCD in a pH environment above 4. Preferably above a pH of 4.5.

Preferably the environment if from 4.5 to 7.

Optionally the SSP has been produced from dicalcium phosphate (TCP) using sulphuric acid and the presence of the basic material(s) has reverted someway back to TCP eg, can be a resultant mix for example of mono calcium and dicalcium phosphate(s) low in free acid(s).

In another aspect the invention consists in a particulate product (preferably granular) that comprises or includes a single super phosphate and/or any reverted form thereof, one or more nitrification inhibitor, and one or more basic material(s) and has or has had included water.

Preferably product has been derived from 30 to 85% w/w single super phosphate.

Most preferably the single super phosphate is or was present in the range from 50 to 80% w/w.

Still more preferably 60% to 70% eg, most preferably about 65%.

Preferably the nitrification inhibitor is from 1 to 35% w/w.

A preferred nitrification inhibitor or selection of nitrification inhibitors is or includes but is not limited to DCD.

Preferably said basic material(s) comprises from 1 to 15% w/w.

Preferably said basic material(s) is (are) one or more of Limestone, Burnt Lime, Hydrated Lime, Dolomite, Magnesite, Calcined Magnesite, Dunite, serpentine or Hydrated Magnesium Oxide (“basic material(s)”).

Optionally water is present eg, up to 20% w/w water although it can be down to zero.

In a further aspect the present invention consists in a particulate product substantially as previously described that has been made by one or more method typified by methods 1 and/or 2 substantially as hereinafter described.

In another aspect the invention is a method of providing a granular nitrification inhibiting product, said method comprising or including

mixing a superphosphate with both particulate DCD and basic material(s), and

granulating the mixture.

Preferably the superphosphate is fresh SSP.

In a further aspect the invention consists in a method of providing a particulate product which comprises ox includes the steps of

providing a thick slurry of single super phosphate (preferably fully cured SSP), the nitrification inhibitor (preferably DCD) and water,

adding basic material to the thick slurry, or vice versa,

granulating the resulting reverted and/or reverting SSP mixture to provide said particulate product.

In another aspect the invention is a method of providing a granular nitrification inhibiting product, said method comprising or including

combining a superphosphate and particulate DCD with basic material(s) in the presence of water to provide a mixture, and

granulating the mixture.

Preferably the superphosphate is a SSP.

Preferably the SSP is fully cured prior to associate with the DCD.

In a further aspect the present invention consists in a granular product comprising

30 to 85% single super phosphate,

1 to 35% DCD and from

1 to 15% basic material(s).

Preferably the basic material(s) is (are) chosen from Limestone, Burnt Lime, Hydrated T.iine, Dolomite, Magnesite, Calcined Magnesite, Dunite, serpentine AND Hydrated Magnesium Oxide.

Preferably the granular product is hard (for example, a granular crush strength greater than 5 kg), and/or has a bulk density greater than 1 g/ml (for example about 1.2 g/ml).

In still a further aspect the present invention consists in the aforementioned process(es) and the additional optional step (irrespective of whether or not a flow enhancing agent has been utilised) of admixing or otherwise associating the reverted super phosphate and/or basic material(s) carried nitrification inhibitor(s) with a fertilising agent, compound or composition irrespective of whether or not it includes nitrogen.

Nothing herein precludes other agents in addition to the nitrification agent(s) also being carried.

In a further aspect the invention consists in a method of producing a particulate composition suitable (alone or in conjunction with at least one other material) to be applied to the soil and/or pasture, said method comprising or including reverting a superphosphate carrier, or as a carrier, of a compatible nitrification inhibitor.

In a further aspect the invention consists in a method of producing a particulate composition suitable (alone or in conjunction with at least one other material) to be applied to the soil and/or pasture, said method comprising or including granulation of a reverted superphosphate, or a superphosphate adapted to revert, carrier, or as a carrier, of a compatible nitrification inhibitor.

In a further aspect the invention consists in a method of forming a granular product which comprises or includes the steps of

mixing fresh SSP with the nitrification inhibitor and basic material(s), and

granulating the material.

Preferably the fresh SSP is, by way of example, 20 minutes since mixing acid with the rock and is at about 80° C.

Preferably said basic material(s) is selected from one or more of Limestone, Burnt Lime, Hydrated Lime, Dolomite, Magnesite, Calcined Magnesite, Dunite, serpentine or Hydrated Magnesium Oxide.

Preferably the nitrification inhibitor is DCD (a preferred composition is one where the DCD has been finely ground).

Preferably both the SSP and DCD are finely ground.

In another aspect the invention is a granular product or composition, and any use thereof, such product or composition being made by one of the methods previously defined.

The term “nitrification inhibitor” or its plural refers to any suitable compound or compounds and is inclusive of those discussed above.

The term “basic material(s)” includes those exemplified and/or any materials able fully or in part to revert the super phosphate or deny any substantial presence of a free acid moiety.

As used herein the term “slurry” is not restrictive to solely water carried particle mixtures but preferably includes water in the liquid or has water as the sole liquid.

As used herein the term “and/or” means “and” or “or”, or both.

As used herein the term “(s)” following a noun includes, as might be appropriate, the singular or plural forms of that noun.

In this specification where reference has been made to patent specifications, other external documents, or other sources of information, this is generally for the purpose of providing a context for discussing the features of the invention. Unless specifically stated otherwise, reference to such external documents is not to be construed as an admission that such documents, or such sources of information, in any jurisdiction, are prior art, or form part of the common general knowledge in the art.

A preferred formulation is a w/w formulation as follows:
30-85% Single Super Phosphate (“SSP”), preferably 65%
0-20% Water
1-35% Dicyanodiamide (“DCD”)
1-15% Basic material chosen from, Limestone, Burnt Lime, Hydrated Time, Dolomite, Magnesite, Calcined Magnesite, Dunite, Serpentine or Hydrated Magnesium Oxide.

However other compositions are contemplated.

The invention will also be described with reference to trials conducted with three DCD including compositions in a closed soil incubation experiment the results of which are shown in the attached drawings in which

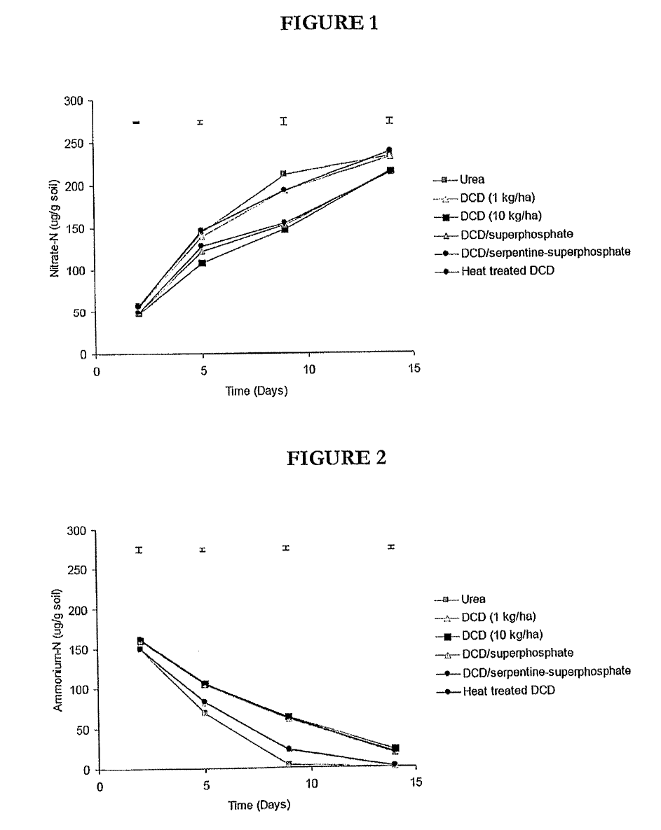

FIG. 1 shows the results of nitrate and ammonium analyses of soil incubated with different treatments, showing changes in nitrate-N concentration in soil over time as affected by the three DCD including compositions compared to DCD, and

FIG. 2 shows change for the same analyses changes in ammonium-N concentration in soil over time as affected by the three DCD including compositions compared to DCD.

Some preferred embodiments will now be described with reference to methods and at least one example of each method.

Examples of methods of preparation and composition examples are as follows but are not restrictive.

Method 1:

Water, DCD and fully cured SSP are slurried together to form a thick paste. The basic material is added and the resulting reverted SSP mixture is granulated.

It is advantageous, but not essential, that both the SSP and DCD are finely ground.

Finely ground is ˜95% passing 100 um sieve.

The grinding can occur in both the dry form or in the slurry by the use of a silverston type blender.

### EXAMPLE 1

78 gram SSP, 25 gram Water, 25 gram DCD were slurried together to form a thick paste. 4 grams of MgO were added and the resulting mixture granulated.

The resulting material had a water soluble DCD content of 20% w/w, was hard (granular crush strength >5 kg) and a bulk density ˜1.2 g/ml).

### EXAMPLE 2

78 gram SSP, 25 gram Water, 20 gram DCD and 5 grams of Ammonium Thiosulfate (99.5%) were slurried together to form a thick paste. 4 grams of MgO were added and the resulting mixture granulated.

The resulting material had a water soluble DCD content of ˜16% w/w, was hard anular crush strength >5 kg) and a bulk density ˜1.2 g/ml).

### EXAMPLE 3

78 gram SSP, 25 gram Water, 20 gram of Ammonium Thiosulfate (99.5%) were slurried together to form a thick paste. 4 grams of MgO were added and the resulting mixture granulated.

The resulting material was hard (granular crush strength >5 kg) and a bulk density ˜1.2 g/ml).

Method 2:

Fresh SSP, (20 min since mixing acid and rock, ˜80° C.) is mixed with Basic material and DCD. The material is granulated in a standard industrial fertiliser granulation system (pan or drum).

It is advantageous, but not essential that the DCD is finely ground or finely ground in before addition.

Finely ground is ˜95% passing 100 um sieve.

### EXAMPLE

SSP was manufactured using 16% w/w P Phosphate Rock, Sulfuric Acid and Water having an acid to rock ratio of 0.58. The mixture was cured for 25 min before the addition of 15% w/w finely ground Serpentine rock. 20% w/w DCD was then added and well mixed. The resulting solid was granulated.

SSP revert in this way by the addition of Serpentine Rock or Dunite, is latter referred to as Serpentine Superphosphate.

The addition of the basic material(s) in Method 2 avoids DCD degradation. Without the removal of the free acid, degradation of the DCD occurs and the resulting product has reduced or little nitrification inhibition.

In use, the granules can be applied conventionally for purposes including those discussed at the outset.

Incubation Trials—Comparison of Three DCD Including Compositions to DCD Alone

Dicyandiamide (DCD) has been proven as an effective inhibitor of nitrification in soil (Amberger 1989).

We see the advantageous propect of DCD being applied with superphosphate to reduce the number of product applications on-farm.

However, the affect of mixing DCD with fertilisers is uncertain. This is particularly so if added at a processing stage when relatively high temperatures may occur.

We have prepared for trials a mix of DCD and phosphate fertilizers. One :nix is a DCD/single superphosphate (“SSP”) mix reverted by the addition of MgO following the Example provided for Method One. The other mix is a DCD/serpentine-superphosphate ie, Example 2 following the method detailed in Method 2. These compositions were prepared to test their effectiveness in nitrification inhibition when compared to DCD alone to ensure that their effectiveness was not affected by the mixing process.

We have also prepared a third DCD including composition. This is a material that is the product of heat treating DCD. The heat treating simulates what may occur during the process of fertiliser production. Analyses of the product showed that it contained 10% w/w DCD and the rest of the initial DCD was converted to some other product most probably melamine. It was expected that the measurable DCD content would inhibit nitrification but the effectiveness of the other components was uncertain

The heat treated product was included to anable trialling to determine whether the other components formed as a result of the heating had any nitrification inhibition properties.

A closed soil incubation experiment was established with the three compositions or products. The heat treated DCD was added at 10 kg/ha and the DCD/P fertiliser blends were added at 10 kg DCD/ha equivalent.

A control (urea only) and 2 DCD rates (10 kg DCD/ha and 1 kg DCD/ha) were included. Ten kg/ha is a standard rate of DCD application and matches the DCD/P fertiliser rate while 1 kg/ha matches the DCD rate applied in the heat treated product which was 10% w/w DCD. All treatments received urea solution at approximately 200 kg N/ha, and were replicated three times.

The soil was a Horotiu silt loam (Yellow Brown Loam) collected to a depth of approximately 100 mm from a site on the Ruakura farm. The soil was sieved through a 4 mm sieve and stored at 4° C. overnight. Sub-samples were taken to determine the moisture content, soil water holding capacity and initial inorganic N concentration. To measure moisture content, subsamples were dried at 105° C. for 24 hours.

Stock solutions of urea, DCD and heated treated DCD were prepared. The compositions were diluted in water to aid dispersion through the soil and the more accurate addition of small amounts of material, The DCD/fertiliser blends however were weighed and applied dry as the material was largely insoluble.

Each replicated treatment was added to 150 g of dry soil equivalent (195 g field moist soil) in a resealable plastic bag. Distilled water was added as necessary to increase the soil moisture to around 60% of water holding capacity. The contents of each bag were mixed thoroughly, and the bags sealed to include as much air as possible to ensure an aerobic environment was maintained. The bags were placed in an incubator set at 20° C. for the duration of the experiment (14 days).

Sampling and Analysis

Soil sub-samples were taken from the bags at 2, 5, 9 and 14 days after incubation commenced for ammonium and nitrate analysis. The equivalent of approximately 5 g dry weight of soil was weighed into 150 mL flasks, 50 mL of 2 M potassium chloride (KCl) was added and the flasks shaken for one hour using end-over-end shakers (Mulvaney, 1996). The extractant was filtered (Whatman #42 filter paper) before being frozen prior to analysis for nitrate-N and ammonium-N using a Skalar segmented flow analyser. The data were statistically analysed using the ANOVA directive of GenStat (10th Edition) and L.S.D. (least significant difference) were calculated.

### RESULTS AND DISCUSSION

The results of nitrate and ammonium analyses of soil incubated with the different treatments are shown in FIGS. 1 and 2 and Tables 1 and 2.

TABLE 1
Average nitrate concentration in soil (μg NO₃—N/g soil)

| Treatment | Day 2 | Day 5 | Day 9 | Day 14 |
|---|---|---|---|---|
| DCD (1 kg/ha) | 55.8 | 139.4 | 193.7 | 233.8 |
| DCD (10 kg/ha) | 48.1 | 108.7 | 148.1 | 216.6 |
| DCD/superphosphate | 48.9 | 122.0 | 152.9 | 215.8 |
| DCD/serpentine- | 48.9 | 128.6 | 155.2 | 215.1 |
| superphosphate | | | | |
| Heat treated DCD | 55.9 | 147.0 | 194.2 | 239.4 |
| Urea | 57.5 | 144.8 | 212.9 | 234.4 |
| L.S.D. | 1.6 | 5.0 | 7.7 | 6.4 |

TABLE 2
Average ammonium concentration in soil (μg NH₄—N/g soil)

| Treatment | Day 2 | Day 5 | Day 9 | Day 14 |
|---|---|---|---|---|
| DCD (1 kg/ha) | 149.7 | 81.6 | 23.2 | 1.3 |
| DCD (10 kg/ha) | 159.7 | 106.2 | 63.1 | 22.1 |
| DCD/superphosphate | 159.6 | 105.1 | 60.3 | 17.8 |
| DCD/serpentine- | 161.2 | 106.3 | 62.2 | 18.7 |
| superphosphate | | | | |
| Heat treated DCD | 148.8 | 82.8 | 21.9 | 0.9 |
| Urea | 148.8 | 68.5 | 3.6 | −0.1 |
| L.S.D. | 7.6 | 4.2 | 6.2 | 4.2 |

The results show that the nitrification inhibition of the DCD/P fertiliser blends was not significantly different (P<0.05) from the inhibition demonstrated by DCD alone at the same rate (10 kg DCD/ha). This suggests that the blending of DCD and the two phosphate fertilisers had no adverse effect on nitrification inhibition and that DCD was just as effective when mixed with P fertiliser as it was alone.

The heat treated DCD product which contained about 10% DCD inhibited nitrification to the same extent as the equivalent (1 kg/ha) DCD treatment and was significantly different from the control (P<0.05). However, nitrification inhibition was significantly lower (P<0.05) than in the treatment with the normal rate of DCD (10 kg/ha).

It appears that the heat treated DCD is only as effective as the amount of DCD it contains and the other constituents of the product have no nitrification inhibition properties. This indicates that care should be taken to avoid high temperatures when dealing with products containing DCD.

1. A particulate composition or granules for soil or pasture application in the form of particulate reverted super phosphate(s) carrying, in intimate contact or admixture, at least one nitrification inhibitor in a pH environment of at least.

2-33. (canceled)

34. The composition or granules of claim 1 substantially free of any free acid.

35. The composition or granules of claim 1 wherein the reverted superphosphate is a SSP.

36. The composition or granules of claim 1 wherein the reverted superphosphate is a DSP or TSP.

37. The composition or granules of claim 1 wherein the reverted superphosphate is two or more of the group SSP, DSP and TSP.

38. The composition or granules of claim 1 wherein the reverted superphosphate is Serpentine Superphosphate.

39. The composition or granules of claim 1 where the nitrification inhibitor(s) is (are) particulate.

40. The composition or claim 1 wherein the nitrification inhibitor is, or nitrification inhibitors are selected from the group DCD, Nitrapyrin and pyrazole derivatives.

41. The composition of claim 39 wherein the pyrazole derivatives are x-y.

42. The composition or granules of claim 1 wherein the nitrification inhibitor is from 1 to 35% w/w of the composition.

43. The composition or granules of claim 1 containing 30 to 85% single super phosphate.

44. The composition or granules of claim 1 having a granular crusn strength greater than 5 kg, and a bulk density greater than 1 g/ml.

45. The composition or granules of claim 1 wherein the nitrification inhibitor(s) is or includes DCD.

46. A particulate product or granulated product that comprises or includes a single super phosphate (SSP) and/or any reverted form thereof, one or more nitrification inhibitor selected from one or more of the group consisting of DOD, Ndtrapyrin and pyrazole derivatives, and one or more basic material (s and has or has had included water;
and wherein the nitrification inhibitor (a) is in an environment of at least a pH of 4.

47. The method of potentiating and/or stabilisJng the nitrification inhibition of a nitrification inhibitor as deliverable granules as claimed in claim 1 which comprises or includes coupling the nitrification inhibitor selected from one or more of the group consisting of DCD, Nitrapyrin and pyrazole derivatives, prior to granulation with a reverted super phosphate or a system, to provide a reverted superphosphate or a system of one or more superphosphate at least substantially free of free acid such that the nitrification inhibitor is in a pH environment of at least 4.

48. The product of claim 46 having from 0 to 20% w/w water.

49. The method of providing a granulated product of claim 46, said method comprising or including
mixing a superphosphate with both particulate DCD and basic material(s) such that the DCD is in an environment of a pH of at least 4, and granulating the mixture.

50. The method of providing a particulate product of claim 49 which comprises or includes the steps of
providing a thick slurry of single super phosphate, a nitrification inhibitor selected from one or more of the group consisting of DCD, Nitrapyrin and DMPP and water,
adding basic material to the thick slurry, or vice versa, such that the DCD is in an environment of a pH of at least 4 granulating the resulting reverted and/or reverting SSP mixture to provide said particulate product.

51. The method of providing a granular product of claim 49, said method comprising or including
combining a superphosphate and particulate DCD with basic material(s) in the presence of water to provide a mixture such that the DCD is in an environment of a pH of at least 4, and granulating the mixture.

52. The method of claim 47, having the additional optional step (irrespective of whether or not a flow enhancing agent has been utilised) of admixing or otherwise associating the reverted super phosphate and/or basic material(s) carried nitrification inhibitor(s) with a fertilising agent, compound or composition irrespective of whether or not it includes nitrogen.
